(19) United States
(12) Patent Application Publication
(10) Pub. No.: US 2006/0004890 A1
(43) Pub. Date: Jan. 5, 2006

(54) Methods and systems for providing directory services for file systems

(75) Inventors: Bruce P. Semple, Potomac, MD (US); Frank L. Stein, Vienna, VA (US)

Correspondence Address: Jason E. Gorden;HOVEY WILLIAMS LLP, Suite 400, 2405 Grand Boulevard, Kansas City, MO, 64108-2519, US

(73) Assignee: International Business Machines Corporation, Armonk, NY (US)

(21) Appl. No.: 10/865,215

(22) Filed: Jun. 10, 2004

(51) Int. Cl. G06F 17/30

(52) U.S. Cl. 707/204

(57) ABSTRACT

Methods and systems are disclosed for providing incremental backup and restore operations for a file system having a large number of files. A file system accessing a mass storage device is augmented by including an enhanced directory services component (EDSC) that has an associated EDSC database that contains file system information regarding contents of the file system including file attributes. Accordingly, high-performance backup and restore operations can be performed by directly or indirectly querying the EDSC database to obtain fill attributes rather than traversing the file system's native file attribute data structures. This enables the file system to provide more consistent response to applications requesting file status independent of the number of files stored in the file system.

### FIELD

The present teaching relates to methods and systems for providing enhanced directory services for file systems.

### BACKGROUND

With the costs of disks decreasing and the capacity of disks increasing, it is now possible to create file systems that can store millions of individual files. Systems that might contain large numbers of files include content libraries and archives, print-on-demand systems (where each page may be a file), and large web sites. Systems with millions of files will become more common as content builds up over time, and as government records retention regulations such as DOD 5015.2 take effect.

Because of the ever present possibility of hardware failure, such as, a mass storage system failure, a fire or natural disaster, or other types of potential disasters, it is important to continually create on-site and off-site backups of important information. Off-site backups on removable media, such as magnetic tape, can be made on-site and moved periodically to off-site facilities. Further, off-site backups can be made remotely, for example, over a network connection. Backups can be made on relatively fast mass storage media such as disk farms or on sequential access-type media such as magnetic tapes. Groups of such magnetic tapes can be managed automatically, for example, by way of a tape robot. When backing up file systems with large numbers of files problems are encountered with the directory structure of known file systems.

Specifically, when faced with the challenge of managing a directory structure containing millions of directories and/or files, the directory services component (DSC) of traditional file systems begins to break down. For example, some file systems employ a table of pointers or INODES to point to file contents and to store information regarding file attributes such as the last modified timestamp. Because the file attributes are stored in such a file system's INODES, to access information regarding a particular file can require a complex traversal of the INODES data structure.

When such a file system contains a large number of files, the directory services component of the file system is unable to answer file attribute queries from external applications in a timely manner, for example as the number of INODES increases into the millions. An external application that pushes the directory services component to the limits is backup and recovery software. The act of creating an incremental backup requires the backup application to request from the file system the file attributes of every single file stored in the file system. A typical backup application traverses a particular file system's file directory structure to determine which files have been created or changed since the last backup, and thus need to be backed up.

Traversing a file system containing millions of files, even if few of the files have been created or changed, can take many hours or even days. This is because there is considerable work involved in looking at each file's directory entry in the file system to discover the files that have been created or modified. Those files that have been modified or created have to be transferred to the backup storage

Restoration processes are also problematic for large file systems. While a backup operation can be done incrementally, i.e., as new files are created, if a disaster occurs, the restore process would have to be done immediately and for all files. This could take multiple days depending on the number of files and the size of the files. In many cases production operations cannot resume until all the files are restored on the system, creating a significant outage.

Accordingly, systems and methods are needed that provide for enhanced directory services in connection with file systems containing a large number of files. Moreover, there is a need for enhanced directory services to facilitate backup and restore of file systems having large numbers of files.

### SUMMARY

According to various embodiments, the present teachings involve methods for incremental archiving of information. In order to perform archive operations consistent with the present teachings, an enhanced directory services component (EDSC) captures information regarding creation and modification of files in a file system, including dates and/or times at which a file was created or modified. In various embodiments, the information regarding creation and modification dates and/or times is stored in a database associated with the EDSC. First an incremental threshold time is established. Then a query is provided via an exemplary EDSC to a database comprising information regarding contents of a file system, where the query is for an identification of modified files that have been modified since the incremental threshold time. Next a set of modified file identifiers corresponding to the modified files is received. Then file contents of the modified files is archived.

The present teachings also involve apparatus for providing incremental backup and restore operations for a file system having a large number of files. In various embodiments, the apparatus includes a mass storage device and a primary file system logically superposed upon the mass storage device. The primary file system has a primary file system interface comprising a directory services component interface coupled to a database comprising information regarding contents of the primary file system. The apparatus also includes a computer-implemented application being performed by a processor, where the application accesses files in the primary file system via the primary file system interface, and the application is operable to access file attribute information associated with files on the primary file system.

The present teachings also involve a method for incremental restoration of a primary file system containing a large number of files. First the primary file system is initialized. Then an EDSC database associated with the primary file system is restored. The EDSC database comprises file system contents information regarding contents of the primary file system and contents of an archive source corresponding to the primary file system. Next, a plurality of requests to open a plurality of files associated with the primary file system is received. Then it is determined by way of an EDSC coupled to the EDSC database whether a requested file in the plurality of files can be provided from the primary file system. Then a restore request is initiated to restore the requested file from the archive source if the requested file cannot be provided from the primary file system.

Advantages of various embodiments include the ability to quickly, incrementally backup a very large file system, having a large number of files, without the time-intensive need to traverse the directory structure of a conventional file system. Additional advantages include the ability to quickly restore and place into service, a very large file system, having a large number of files, if the primary file system ever becomes damaged or must otherwise be rebuilt.

It is understood that both the foregoing general description and the following description of various embodiments are exemplary and explanatory only and are not restrictive of the invention as claimed. The accompanying drawings, which are incorporated in and constitute a part of this specification, illustrate some embodiments, and together with the description serve to explain the principles of the embodiments described herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 illustrates a computer system having an application and a file system consistent with the present teachings;

FIG. 2 illustrates an exemplary embodiment of an enhanced directory services component (EDSC) consistent with the present teachings;

FIG. 3 illustrates an embodiment of an exemplary process diagram for performing backup operations consistent with the present teachings;

FIG. 4 illustrates an embodiment of an exemplary process diagram for performing restore operations consistent with the present teachings; and

FIG. 5 illustrates an exemplary process diagram for performing background restore operations consistent with the present teachings.

### DESCRIPTION OF VARIOUS EMBODIMENTS

Reference will now be made in detail to some embodiments, examples of which are illustrated in the accompanying drawings. Wherever possible, the same reference numbers are used throughout the drawings to refer to the same or like parts.

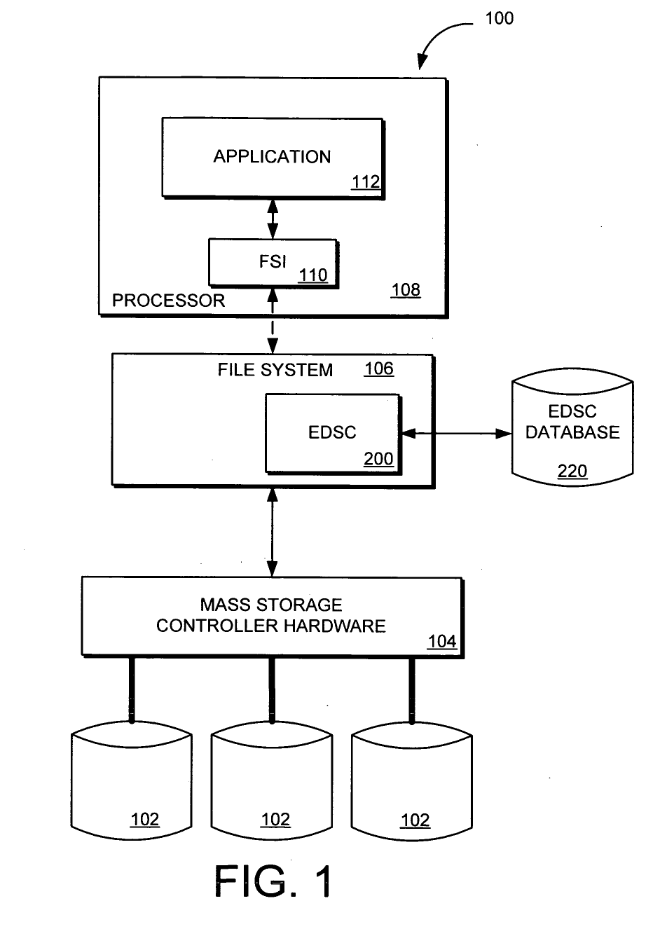

FIG. 1 illustrates a computer system 100 having an application 112 and a file system 106. Mass storage controller hardware 104 provides a hardware interface to mass storage devices 102. The mass storage devices 102 can be mechanical hard disk drives that store information on magnetic disks. It is understood that the mass storage devices can employ other mass-storage technologies, such as optical or electrical storage without departing from the present teachings. The mass storage controller 104 can employ any media access technology including but not limited to small computer systems interface (SCSI), Advanced Technology Attachment (ATA), Serial ATA (SATA), serial, fiber channel or any other media access technology to store and retrieve information from the mass storage devices 102. It is understood that RAID, mirroring, and/or striping technologies can be used to provide speed and redundancy in connection with the mass storage devices 102.

In various embodiments, the application 112 accesses information stored in the file system 106 by making application calls to file system interface (FSI) 110. It is understood that the FSI 110 can be part of an operating system associated with the computer system 100 or the FSI may be a user-space process. The application 112 and FSI 110 can be implemented by way of computer readable instructions that are executed by processor 108. In various embodiments, the application 112 and FSI 110 are stored in an electrical memory from which instructions are fetched and executed by processor 108 according to a general-purpose computer operating paradigm.

It is understood that the FSI 110 can be provided in numerous ways and will generally include a call to open and close a particular file or directory and to access the contents of a particular file or directory. Accordingly, the FSI 110 provides an interface between the application 112, and information stored on the mass storage devices 102.

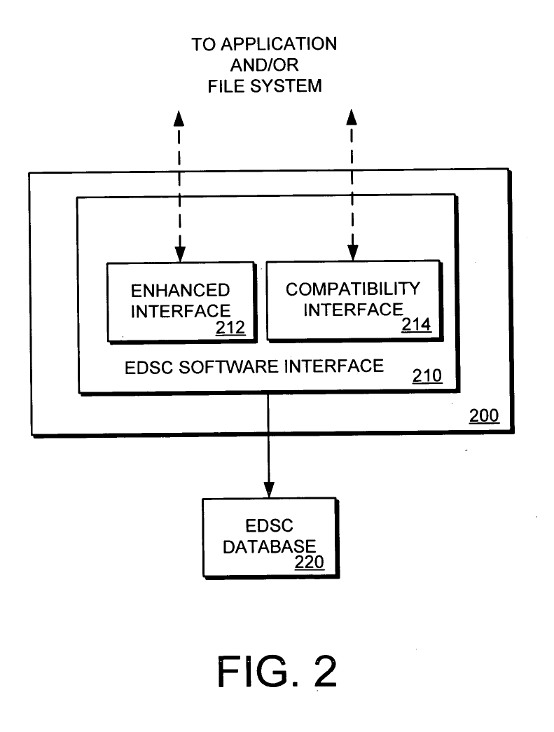

Consistent with the present teachings, information regarding the data stored on the mass storage devices 102 is contained in an enhanced directory services component (EDSC) 200, which is further described in connection with FIG. 2. In various embodiments, EDSC 200 contains information regarding groups of data elements stored in the mass storage devices 102 referred to as files. In various embodiments, a file corresponds to a discrete set of numbers, characters, or blocks of information. For example, a file can contain an ASCII representation of the HTML that is used to implement a particular web page. A file may also contain a string of bits corresponding to an image in a graphics format such as, for example, the TIFF or JPEG graphics formats. In various embodiments, an EDSC database 220 is provided in connection with EDSC 200 as set forth below. It is understood that EDSC database 220 can physically reside on mass storage devices 102 and be accessed through the mass storage controller hardware 104. In alternative embodiments, the EDSC database 220 can physically reside on separate storage media and be accessed through separate controller hardware without departing from the present teachings.

Enhanced Directory Services Component

FIG. 2 illustrates an exemplary embodiment of an EDSC 200 consistent with the present teachings. The EDSC 200 provides information regarding files in a file system as shown in connection with FIG. 1. Information regarding the files in the file system is stored in the EDSC database 220, which, in various embodiments, is a high-speed database used to provide highly responsive access to data regarding the file system, including, for example, file attributes. In various embodiments, the EDSC database 220 is provided in the form of a relational database management system. It is understood that other alternative database implementations can be employed without departing from the present teachings.

EDSC 200 provides access to file system information regarding file attributes via an EDSC software interface 210. In various embodiments, an application communicates directly to an EDSC 200 via enhanced interface 212. In various embodiments, the EDSC 200 is provided so that it replaces an arbitrary file system's existing DSC. This approach preserves the file system's physical I/O characteristics and capabilities. For example, the high bandwidth, horizontal striping characteristics of a General Parallel File System (GPFS) file system would not be affected. In various embodiments only the conventional DSC of a file system is replaced by the EDSC 200.

Additionally, a file system interface, such as FSI 110 of FIG. 1, can communicate via compatibility interface 214, which responds as a conventional native file system interface would respond. However, via the compatibility interface 214, the EDSC 200 responds without the need for traversing the a file system's native directory structure. For example, conventional file systems typically support interface calls such as: open, close, open directory, read, write, seek, and tell, which read from and write to a conventional file system DSC. The compatibility interface 214 provides an FSI that is compatible with applications not written specifically for the enhanced interface 212. Accordingly, by providing the compatibility interface 214 into the EDSC software interface 210, conventional application interface calls to a particular file system indirectly utilize the EDSC 200 and its EDSC database 220, thereby permitting the EDSC to write to its EDSC database 220 file system events such as the modification of a particular file. In various embodiments, the EDSC 200 continues to update the file system's native attributes while also maintaining its EDSC database 220. Moreover, even when using the compatibility interface 214, some file system operations are more efficient than when performed against a conventional DSC, because, for example when looking for a particular file in a directory that has a large number of files the EDSC database 220 can respond more quickly than a conventional directory scan.

In various embodiments, when the EDSC 200 is operating as a replacement to a conventional DSC, the EDSC 200 does not utilize a hierarchy of INODES to store file attributes. Instead, in various embodiments, a high-performance database system is employed as EDSC database 220 to provide file attributes for the various files in the large file system. Accordingly, when a file system contains a large number of files, inquires about file attributes for a particular file can be answered quickly, without having to traverse a tree of INODES, thereby providing a more consistent response independent of the number of files in the file system. Accordingly, EDSC interface 210 can support high-speed, user-level or operating-system-level calls that include, for example, requests for a list of files that have been modified since a particular date and time.

Moreover, in various embodiments, external applications that are written to operate with the EDSC 200 are able to make enhanced remote queries to the EDSC 200 through the enhanced interface 212, such as requesting a list of all the files that have changed since a specified time and date. As set forth below, enhanced remote queries to the EDSC 200 facilitate highly optimized incremental backup operations and restore operations that do not require an application to be down for the entire time it takes to perform a complete file system restore operation.

Backup Operations

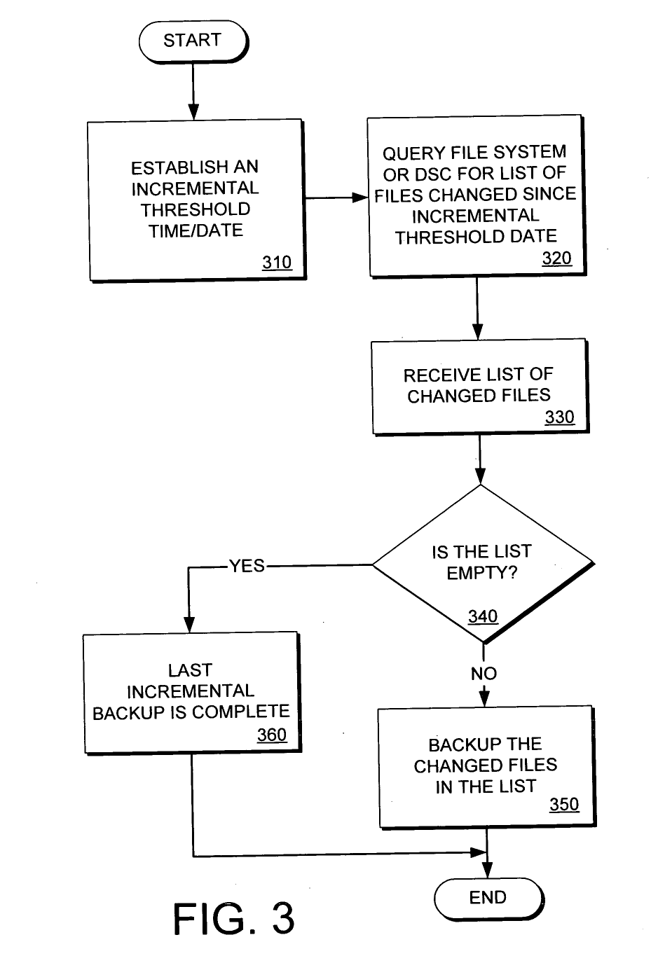

FIG. 3 illustrates an embodiment of an exemplary process diagram for performing backup operations consistent with the present teachings. First, to perform an incremental backup, an incremental threshold time is selected (step 310). The incremental threshold time and/or date typically corresponds to the last date and time a particular backup was made. In various embodiments, the incremental threshold time corresponds to the time and date the last complete backup operation was performed. In various other embodiments the incremental threshold time/date is arbitrarily chosen. Next, the EDSC 200 is queried to obtain a list of files that have changed or been modified since the incremental time (step 320). Consistent with the present teachings, the query performed against the EDSC 200 utilizes a high-speed database, such as EDSC database 220, to determine which files have been changed rather than employing the file system's native data structures reading each INODE to determine which files have been modified since the threshold time. Next, the list of changed files is received (step 330), and it is determined whether the list is empty (step 340). Further, if the list is empty, the incremental backup is complete (step 360). Alternatively, if there are files that have changed since the incremental threshold time, the changed files are backed up to an archive facility. It is understood that any archive source or facility can be employed without departing from the present teachings. Possible archive facilities include local or remote tape backup and local or remote data mirroring on additional mass storage devices such as hard disk drives.

A file system equipped with an EDSC 200 can provide significant performance advantages in file-system backup applications. In order to perform an incremental backup of known file systems, a backup application makes a call to the file system regarding the files stored in the file system so that it can compare the “last modified date” from the file attributes provided by the file system to the date of the file in the last backup. While this operation severely strains known file systems when incremental backups are run, given the conventional strategy of storing file attributes in the hierarchical INODE tree, the present teachings provide a fast response to a request for a list of modified or newly created files.

Accordingly, in various embodiments, a backup application can query the file system, through an EDSC 200, for a list of the files that have changed since a particular date and time, for example the date and time of the last backup, rather than making calls to the conventional file system DSC requesting attributes of every single file in the file system and making a comparison of the time and date attributes with a reference time and date. In various embodiments, such operations are advantageously performed in connection with the EDSC 220, which can be implemented as a relational database management system. Upon receiving, from the EDSC 200, a list of changed files, the backup application can then efficiently retrieve from the file system, only the specific files that have changed and then back up the changed files by writing them, for example, to tape, thereby dramatically reducing the time required to create an incremental backup.

Restore Operations

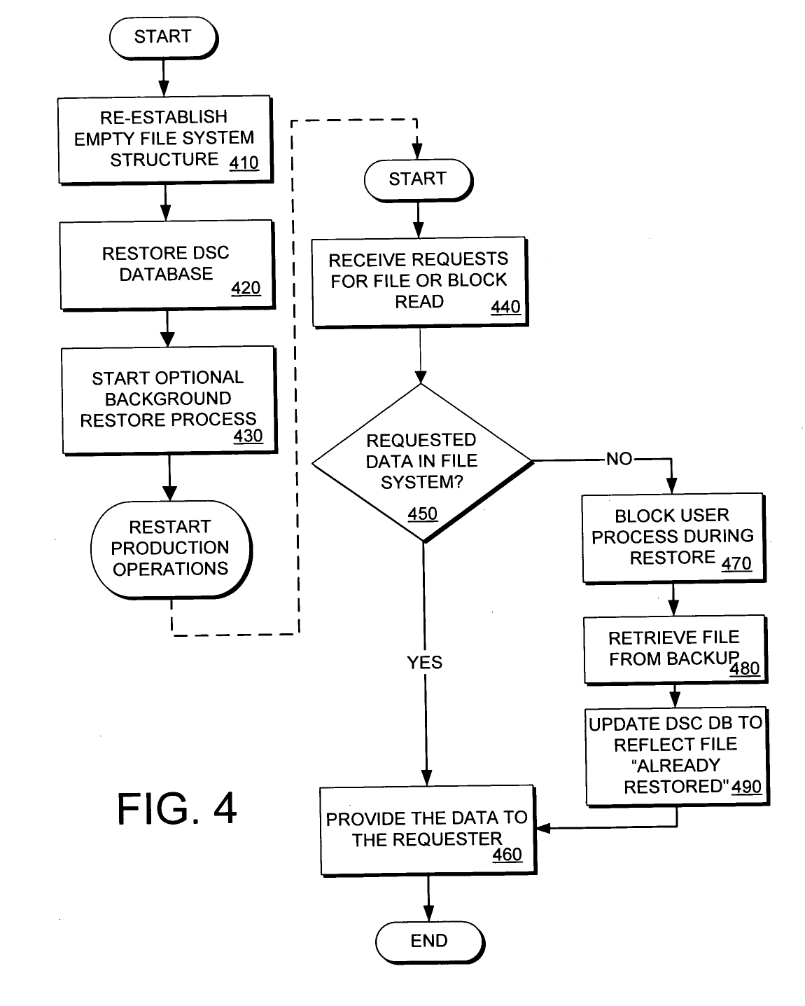

FIG. 4 illustrates an embodiment of an exemplary process diagram for performing restore operations consistent with the present teachings. A file system equipped with an EDSC 200 significantly shortens any production outage time associated with the restoration of a file system, by allowing production applications to be restarted prior to a complete restore operation on a large file system having many files. Once a file system is initialized and its EDSC database 220 restored, which is much smaller than the contents of the file system itself, the file system can begin accepting read and write operations. This is because information regarding the files in the file system being restored is contained in the EDSC database 220, and therefore, files can be restored on an as-needed basis.

Known file system technology requires that complete file-system restoration be completed prior to restarting production application operations, at a potential cost of several hours to multiple days in the case of file systems containing large numbers of files. However, with a file system equipped with an EDSC 200 consistent with the present teachings, the process can operate as follows:

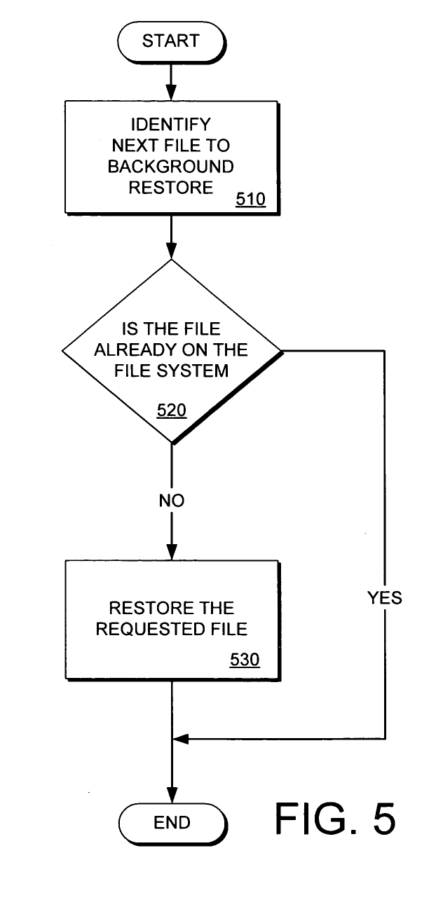

First, an operator restores an empty file system structure of the file system 106 (step 410). Restoring an empty file system can involve, for example, partitioning and reformatting operations. It is understood that initialization of an empty file system can be accomplished in various different ways without departing from the present teachings. Next, the operator restores an EDSC database (step 420), without necessarily restoring all of the data files contained in the file system. Next an optional step of restoring, as a background process, all files in the archive corresponding to the last good state of the primary file system (step 430). This background process executes, for example, when processor 108 of FIG. 1 is not processing application events or instructions or while applications are blocking waiting for input. In this way, a sequential restore of the entire primary file system can be performed in the background. In various embodiments, the optional background restore process consults the EDSC database 220, so as not to restore older files over more recently modified files, as more fully described in connection with FIG. 5.

In various embodiments, production applications can be started at this point while the files are restored in the background. Next the EDSC 200 receives requests to access the file system (step 440). When a particular production application requests to open a file, the EDSC 200 is able to consult its EDSC database 220 to determine if indeed the requested file existed prior to, for example, a crash that resulted in the present disaster recovery operation. At step 450, if the requested file does not exist in the primary file system, but the file does exist in an external archive facility, then a request is sent to the archive facility to restore the requested file. While the archive data is acquired by, for example, retrieving a file from backups, (step 480), executing user processes block execution (step 470). When the files are successfully restored, an optional step of updating the EDSC database 220 to reflect that the file has been restored, is performed so that, for example, the optional background restore process of step 430 will not seek to restore a file that has been restored after being requested by an application or other user process. Thereupon, the data is provided to the requester (step 460).

In various embodiments, if the requested file does not exist on the primary file system and if the requested file is not in the DSC database, i.e. the file is not in the archive facility and did not exist prior to the crash, then a file not found error is returned to the application in a manner analogous to file not found error codes that are provided by known file systems. In various embodiments, the calling application need not be specially designed to work with the EDSC 200 and, therefore, blocks on a compatibility file open call, while the backup application restores the original file to the restored file system. Once the file has been restored, control is returned to the application and it continues execution. Accordingly, in various embodiments, the files are restored as the files are needed by the application.

FIG. 5 illustrates an exemplary process diagram for performing background restore operations consistent with the present teachings. In various embodiments, a full restore is performed as a background, low priority operation. In various embodiments, during a background restore operation, the background restore process identifies the next file to background restore (step 510). Next, the background restore process determines whether the identified file is already on the file system (step 520). If the file is already on the file system, it means that either the application has caused an as-needed restore to occur or has otherwise truncated, created, or modified the identified file, and, therefore, the background restore process should not overwrite the file. Accordingly, if the identified file is determined at step 520 to be on the file system, then the file is not restored to the file system. On the other hand, if the file is not on the file system, then it needs to be restored, and it is restored by the background restore process (step 530).

Accordingly, as described in connection with FIG. 5, in various embodiments, by way of its EDSC software interface 210, the EDSC 200 keeps track of which files have already been restored as a result of application demand or created and/or modified by the application since the last backup was performed. In this way the background restore process will not restore files that have already been restored and/or possibly already created or modified by an application.

In various embodiments, a special-purpose backup application is provided that creates a mirror-image of the file system in an off-site location, for example on removable tape medium or over a local-area or wide-area network. In such embodiments, upon the occurrence of disaster recovery measures, consistent with the present teachings, a file system can be put into production prior to the execution of a complete restoration of all files on the file system, and the EDSC 200 causes an application process block to occur while the EDSC 200 causes the requested file to be fetched and restored to the local file system for use by the production application.

In various embodiments, production applications can utilize off-line or off-site mirrored files rather than blocking on a requested restore and providing access to the file once the restore is accomplished. For example, where an off-site mirror of the local file system exists, an enhanced DSC consistent with the present teachings can fetch the requested file data, via for example a local-area or wide-area network and provide the requested data to the production application. Thereafter, the file can be immediately restored to the local file system, placed in a restore queue, or restored in due course with the remainder of the files to be restored to the local file system.

The term “incremental archiving of information” as used herein refers to a process or operation, whereby recently created or modified information is periodically archived or preserved. Examples include daily or hourly incremental backup operations. The length of the periods at which information is archived can be constant or the periods can vary in length.

The term “incremental threshold time” as used herein refers to a time and/or date to be used to determine the set of files to be archived in connection with an incremental backup operation. Examples include the time the most recent daily or hourly backup was performed. An “incremental threshold time” can also correspond to the time the most recent full backup was restored.

The term “directory services component interface” as used herein refers to a communication mechanism through which an application or operating system communicates with a component of a file system that provides file system attribute information. Examples of file system attribute information include the time and/or date a particular file or directory was most recently created and/or modified.

The term “modified file identifier” as used herein refers to a symbol or tag that establishes the identity of a file that has been modified and/or created since a particular time. Examples include relative or fully qualified file names including relative or complete directory paths and uniform resource identifiers.

The term “primary file system” as used herein refers to a file system that contains the current and authoritative information to be used for a particular purpose.

The term “file attribute information” as used herein refers to information regarding a description of a characteristic of a particular file. Examples include the time the file was created, the time the file was last accessed or modified, and the size of the file.

The term “database” as used herein refers to a collection of information organized especially for rapid search and retrieval. Examples include indexed tables in a relational database management system.

The section headings used herein are for organizational purposes only and are not to be construed as limiting the subject matter described in any way. All literature and similar materials cited in this application, including but not limited to, patents, patent applications, articles, books, treatises, and internet web pages, regardless of the format of such literature and similar materials, are expressly incorporated by reference in their entirety for any purpose.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

What is claimed is:

1. A method for incremental archiving of information, the method comprising:
establishing an incremental threshold time;
providing a query via a directory services component interface to a database comprising information regarding contents of a file system, the query for an identification of modified files, on the file system, that have been modified since the incremental threshold time;
receiving a set of modified file identifiers corresponding to the modified files; and
archiving file contents of the modified files.

2. The method of claim 1, wherein the modified files comprise newly created files and the set of modified file identifiers comprises a set of newly created file identifiers.

3. The method of claim 1, wherein the database is part of a relational database management system.

4. The method of claim 1 further comprising:
determining whether the set of modified file identifiers is an empty set; and
based on whether the set of modified file identifiers is the empty set, providing an indication that the archiving step is complete.

5. Apparatus for providing incremental backup and restore operations for a file system having a large number of files, the apparatus comprising:
at least one mass storage device;
at least one primary file system logically superposed upon the mass storage device, the primary file system having a primary file system interface comprising a directory services component interface coupled to a database comprising information regarding contents of the primary file system, wherein the database contains file attribute information; and
at least one computer-implemented application being performed by a processor, the application accessing files in the primary file system via the primary file system interface, wherein the application is operable to access the file attribute information from the database.

6. The apparatus of claim 5, wherein the directory services component interface comprises an enhanced interface and a compatibility interface, the enhanced interface comprising computer-readable instructions for processing arbitrary queries regarding the contents of the file system and the compatibility interface comprising computer-readable instructions for processing regular file system application interface requests to the primary file system.

7. The apparatus of claim 6, wherein the arbitrary queries comprise a query to provide an identification of files that have been modified since a specified time.

8. The apparatus of claim 6, wherein the regular file system application interface requests comprise:
a file open request;
a file close request; and
at least one file read and write request.

9. A method for incremental restoration of a primary file system containing a large number of files, the method comprising:
initializing the primary file system;
restoring a directory services component database associated with the primary file system, wherein the directory services component database comprises file system contents information regarding contents of the primary file system;
receiving a plurality of requests to open a plurality of files associated with the primary file system;
determining by way of a directory services component coupled to the directory services component database whether a requested file in the plurality of files can be provided from the primary file system; and
initiating a restore request from an archive source if the requested file cannot be provided from the primary file system but can be provided from the archive source.

10. The method of claim 9 further comprising:
initiating a background restoration process for archived files in the archive source that were previously on the primary file system.

11. The method of claim 9 further comprising:
blocking process execution for the plurality of requests to open until after the restore request is processed at the archive source.

12. The method of claim 10 further comprising:
restoring the requested file from the archive source to the primary file system.

13. The method of claim 10 further comprising:
providing, to a requesting application, file contents of the requested file prior to restoration of the requested file.

14. The method of claim 13 further comprising:
querying the directory services component for a determination regarding whether the requested file ever existed in the archive source; and
providing an error condition indication to the requesting application if the requested file did not exist.

15. The method of claim 9 further comprising:
mirroring the primary file system to a secondary archive destination.

16. The method of claim 9 further comprising:
starting production applications that utilize files that were previously stored on the primary file system prior to a complete restoration of the primary file system.

17. The method of claim 9, wherein the large number of files is greater than ten million.

18. The method of claim 9, wherein the directory services component database further comprises information regarding contents of the archive source corresponding to an archive of the primary file system.
